(19) United States
(12) Patent Application Publication
(10) Pub. No.: US 2008/0154503 A1
(43) Pub. Date: Jun. 26, 2008

(54) Method and Associated System for Wireless Medical Monitoring and Patient Monitoring Device

(75) Inventors: Jan Wittenber, Andover, MA (US); John L. Barga, Bedford, MA (US); Brian S. Rosnov, Melrose, MA (US); Andrew G. Koschek, Ashland, MA (US)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 10/598,063

(22) PCT Filed: Feb. 1, 2005
(86) PCT No.: PCT/IB05/50427

§ 371 Date: Aug. 17, 2006

Related U.S. Application Data
(60) Provisional application No. 60/545,819, filed on Feb. 19, 2004.

(51) Int. Cl. H04L 12/28

(52) U.S. Cl. 701/300

(57) ABSTRACT

A method for paging/finding a wireless patient-monitoring device in a WLAN network includes the steps of determining the status of a radio module (RM) (117) of one or more wireless monitoring devices comprising one of a Patient-Wearable Device (PWD) (115a,115b) and a Patient-Monitoring Device (PMD) (110a,110b) that are adapted for dual-communication with one of or more Access Points (104,106) and a central-monitoring station in a WLAN. The overall status of the PWD/PMD can be a plurality of meta-states including standby, inactive, active, sleep. After the status is determined, there is a selection of a particular PWD/PMD for receipt of wireless transmission of a signal that is adapted for changing a meta-state of the device to a desired state if the current state of the particular wireless monitoring device is not the desired state. An audial-code function of the particular wireless monitoring device is activated by transmitting an instructional signal to the particular wireless patient-monitoring device to emit a predetermined first audial-code that can be heard at least by a patient being monitored by the particular PWD/PMD, so that the patient is instructed to contact the nurse's station. Alternatively, or in addition thereto, a second audial tone may be broadcast that is emitted at a volume loud enough to permit a clinic or facility personnel to walk around and locate the device by the sound.

The present invention relates to data communications protocol used for wireless medical telemetry systems (WMTS) device management. More particularly, the present invention relates to the functional management of Internet and DECT-based protocols.

Digital Enhanced Cordless Telecommunication (DECT), which originated as a European initiative, has become popular around the world to provide efficient access to many different types of applications and services. DECT based systems are becoming increasingly popular, particularly in the field of wireless medical telemetry systems, with Patient-Wearable Devices (PWD) that are capable of monitoring, for example, patient vital signs, and reporting wirelessly to a host or monitoring station.

Preserving battery power is a desirable goal, and of all the operational functions of the PWD, the wireless transmission function utilizes the most power. Thus, such devices can be engineered with sleep modes, where the devices do not have to be fully powered up and receive a wakeup signal to become fully activated. Ideally, a range of low-power states above that of a sleep mode would be desirable so that a patient wearing a PWD could quickly contact a member of the nursing staff or a misplaced device could be easily located.

However, present generation telemetry infrastructures are not capable of advanced functions regarding reduced power modes. The present state of the art “TeleVision” technology provides only unidirectional “simplex” capability (i.e. from the device to a central site) and the infrastructures lack the AP proxy functions and/or wireless bidirectional capability, as well as a built-in control protocol or associated application meta-state machine model.

The present invention provides a data communications protocol that enables several medical device management functions using specialized Internet and DECT-based protocols. In particular, the present invention permits a wireless medical device in a very low power state to resume normal operation after being paged from a “standby” mode, and/or by emitting audial indications if not resuming normal operation, based on its persistent meta-state.

One way the present invention can function is that an Internet control directs the Access Point (AP) in a wireless network to issue a DECT “call” to the wireless medical device. Upon receipt of the DECT call, the device either resumes normal operation from standby mode or makes audial indications that facilitate clinicians to find the device in the event such device was “misplaced” and/or lost. It is a common occurrence in busy clinical settings that wireless medical devices can become misplaced, thus detracting from the ability of clinicians to render direct patient care.

In addition, another aspect of the present invention is that clinicians are enabled to prompt the patients having ambulatory medical telemetry devices so as to immediately contact the nursing staff (directly or by pressing a button on the patient-worn device).

The present invention also automates and increases the range and the scale (in terms of the number of devices concurrently managed) in ambulatory and portable device standby-mode management applications through the use of bidirectional, wireless data communication technology, thereby enabling clinicians to remotely control these operations rather than spending time traversing between the device and the nurse's station or spending time and energy unproductively (relative to rendering direct patient medical care) finding devices or patients.

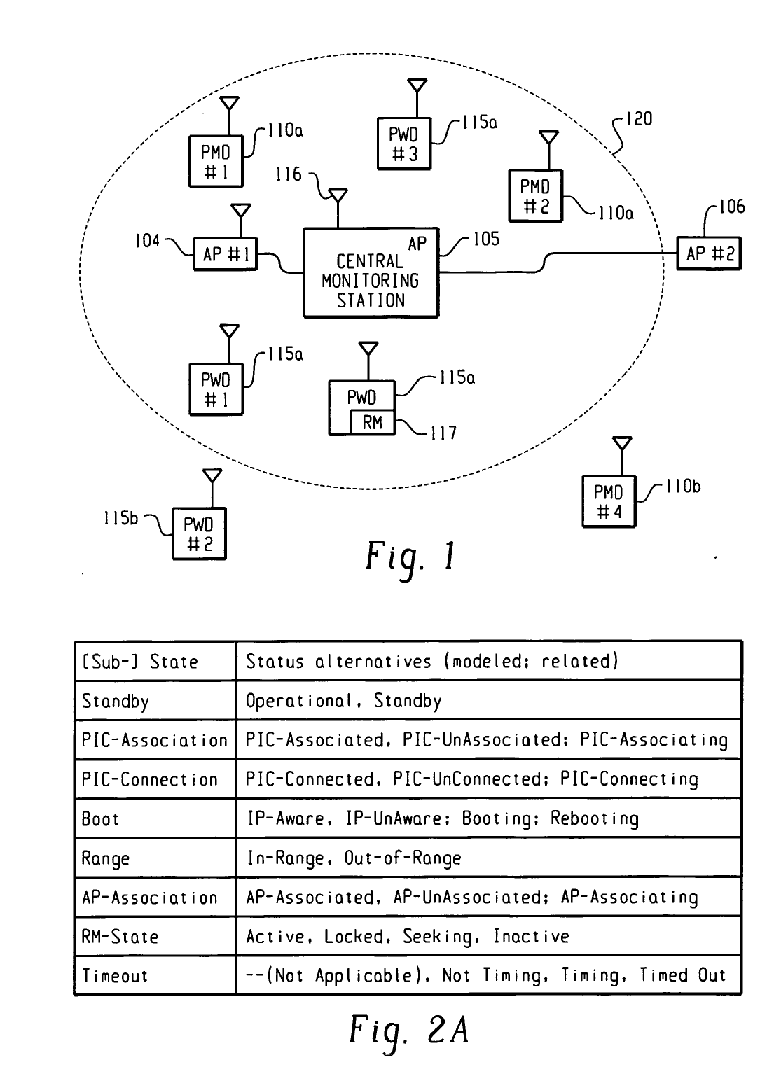

FIG. 1 is an illustration of a system according to the presently claimed invention.

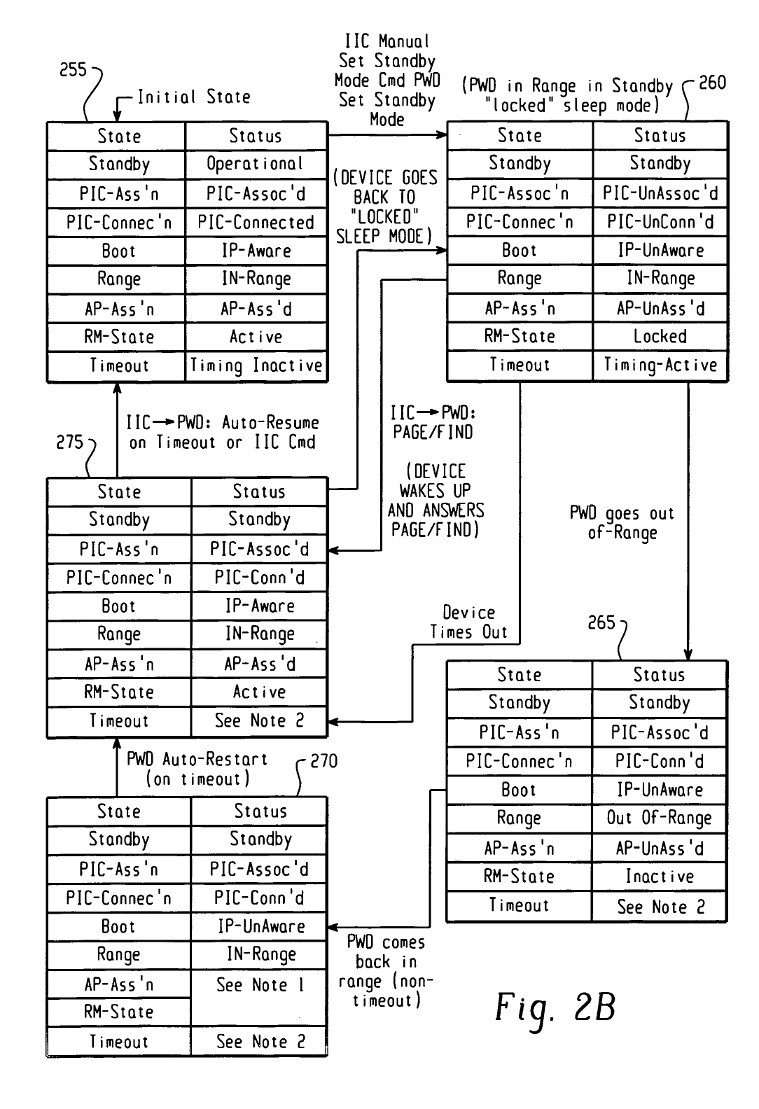

FIG. 2A is an illustration of some of the meta-states that can be used to classify the status of a patient medical device according to the presently claimed invention.

FIG. 2B shows how the meta-states change during typical transitions of a device as it moves through a standby-resume “life-cycle.”

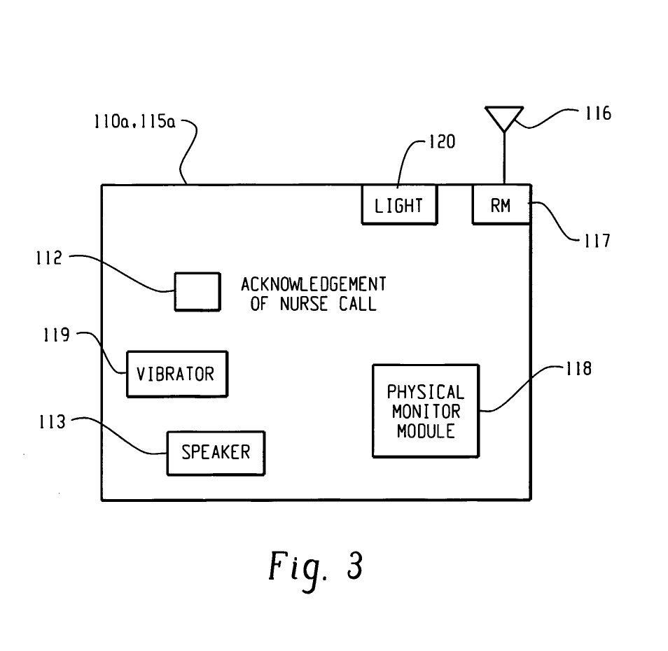

FIG. 3 is a detailed view of some the components that comprise a patient wearable device/patient-monitoring device according to the present invention.

It is to be understood that the following descriptions, which are presented in conjunction with the drawings, are provided for purposes of illustration, not for limitation. A person of ordinary skill in the art will appreciate that there are many variations of the present invention that lie not only within the spirit of the invention but also within the scope of the appended claims.

Several definitions must be expressed in order to truly appreciate the capabilities of the presently claimed invention, particularly the “page/find” and “standby” capabilities of WMTS-WLAN-based devices. These capabilities are made possible by and are so intended to take advantage of the “bi-directional (“duplex”) communication capability of WMTS-WLAN DECT-based technology.

“Page/find” is a capability in which a telemetric medical device can be reached (if within range of an AP) in order to cause it to emit audial indications from the device to facilitate determining the device's location. Alternatively, the page/find capability can be used to prompt a patient to perform a nurse-call function. In either case, the device will respond if its radio module (RM) is in a suitable mode (i.e. in the range of some AP and is not “inactive”). A specialized WMTS-DECT-level function can be used for this function.

“Standby” mode is a capability in which a device can be placed in a sub-operational mode to support “dynamic” care. Stand-by mode occurs only after it has received a confirmation of the request. If the device does not receive the confirmation, then it retries, and if the retries fail, it is assumed that the control failed, and the device should send another “MDS Status ADEdevice” message so as to determine whether the lack of response is because the device is now out-of-range. While in a standby mode, a power-conserving feature of some devices permits a very-low power consumption mode (sleep mode), wherein the device interface's receptivity to messages on the WLAN is effectively limited to being “called” by the AP to wake up. If a device can afford the power, it should try to maintain association even while in Standby mode in order to minimize the time required to “resume latency”; for such purposes only Alert Status updates need to be maintained.

Some of the uses for Standby mode are:

(1) Patient Monitoring Devices (PMD) are typically placed in a standby mode while awaiting a new patient to be assigned to a given bed. Manual resumption of the operational mode, typically initiated from a central is, is acceptable if not required;

(2) Animation Devices are typically placed in standby mode when a patient is ambulating to/from ancillary labs, which may result in Out-of-Range conditions, thus making it more important but complicated to provide automated Page/Find and Resume capabilities, especially when devices are in a power-saving (sleep) mode. In addition, these device are routinely “lost” (i.e. misplaced), sometimes while in standby mode, which further complicates the design.

“Auto-resume” describes a feature of a device that resumes an operational mode from a standby mode. This auto resume would occur typically at the device's end, as opposed to a manual resumption of an operational mode, and typically would be initiated from a central station. However, the device may set a count down timer upon being placed in standby mode, so that when the timer expires, the device automatically resumes a normal mode and sends an MDS status to PIC.

“Auto-reconnect” is a feature that describes a device capability that can respond to a “page/find” message when in-range, and when the device goes out-of-range and has come back in-range, an automatic reconnection takes place because the device periodically seeks connection to the PIC so as to receive a resume control instruction from the PIC when the device is back in-range. Auto-reconnect does not require manual reconnect triggering when the device comes back into range.

FIG. 1 shows a central-monitoring station 105, which might constitute, for example, a nurse's station in a cardiac-care unit, a central medical unit inside a nursing home or hospice facility, or even an emergency room of a hospital. While an emergency room might not initially seem like the environment for the invention, in fact people are serviced according to priority in an emergency room and Patient Wearable Devices could be assigned upon registration to “keep an electronic eye” on the patient's condition, which could unexpectedly worsen.

Patient Monitoring Devices (PMD #'s 1-4) 110 contain wireless telemetry so that in addition to one or more specific physiological responses being measured, the wireless telemetry allows transmission via a protocol such as DECT, TDMA and/or WMTS back to the central-monitoring station 105.

In addition, Patient Wearable Devices (PWD #1-4) 115 also contains wireless telemetry to report physiological data. However, a PWD is worn by the patient, and may comprise, for example, a wristband and/or armband to monitor blood pressure, portable cardiac monitor, temperature sensor, etc. A PWD contrasts with, for example, a bedside heart monitor that is not worn by the patient, but is connected to the patient; such a device would comprise a PMD.

Alternatively, the central-monitoring station may comprise nothing more than an Access Point in a WLAN that is keeping track of nodes within its broadcasting range, and the AP itself could be hardwired, fiber-optically connected, or wirelessly connected to a proxy server, main server or controller.

It is to be understood that the PMD's 110 are somewhat large devices next to a patient's bed, and generally are portable. Should the doctor decide that the patient needs, for example, an MRI, the orderlies can wheel the patient to that area along with the PMD 110 (the PMD has a battery back-up to keep working while being moved).

The dashed line 120 around a portion of FIG. 1 constitutes the RF range of the central-monitoring site 105. The PWD #2 and PMD #4 are out of range of the central-monitoring station 105. If the central-monitoring station 105 is an AP, it is possible that these devices were “handed off” to another AP in the WLAN.

Each of the PMDs and PWDs each has a radio module (RM) that is adapted to be in one of several meta-states (sub-states), such as standby, active, locked, seeking, or inactive. Similarly, the PWD and/or PMDs themselves have an overall status comprising a plurality of meta-states (shown in FIG. 2B and discussed, infra). It is from these different categories of meta-states that the WMTS-WLAN DECT-based protocol determines the appropriate action.

FIG. 2A shows a list of the major sub-states, and their status alternatives. With regard to standby, the device status can be in an operational mode, or on standby. With regard to (Point of Call) PIC-Association, the device could be pic-associated, pic-disassociated, or in the process of pic-associating. With regard to PIC-Connection, the device could be pic-connected, pic-disconnected, or pic-connecting. With regard to booting, the devices can be IP-aware (preserving IP allocated addresses), unaware, booting, or rebooting. With regard to range, the devices can be in-range or out-of-range. With regard to Access Points, the devices may be AP associated, or AP-disassociated.

FIG. 2B illustrates some of the various meta-states that can be used by the present invention. For example box 250 represents an initial state of a PWD device, with the particular state and the status of each state listed. At 255, the standby status is operational, the PIC is associated, the PIC is connected, the boot state is IP Aware, the device is in range of transmission from the PIC. In addition, the Radio Module (RM) state is active, and the timing is inactive.

At box 260 the PWD goes into standby mode, with the RM state locked in the sleep mode. Note that the timing is active because there can be, for example, a count-down timer so that after a predetermined period the PWD device times out and may connect with the PIC so that a page/find capability would activate the PWD, which a central host might be looking to locate. It should be noted that in box 260 the PWD is PIC-unassociated, the PIC is unconnected, the boot status is IP-Unaware and the RM state is locked. The PWD is still in-range.

There are various time-out cases, depending, for example, as to whether or not the PWD is in-range or out-of-range. As the PWD in box 260 is in-range, after timing it may wake up and answer the page/find, thus enabling the device to auto-resume as shown in Box 275. It is noted that by auto-resuming, the RM status is now active, the PIC is associated and connected, and the AP is associated. The PWD may then go back to the initial state while transmitting requested patient-physiological information back to an AP, PIC and/or central host.

However, a different scenario occurs if the PWD goes out-of-range, as in Box 265. Here, if the device times out, it will not be able to receive/respond to a page/find. In box 265 it is shown that the RM-state is inactive. The out of range case shown would allow a device to go to a locked state when in-range and still timing, then allow the device to auto-resume when timed out.

Box 270 shows what happens when the PWD that was out of range comes back into range. In this case, the PWD had not yet timed out. Upon timeout, an auto-restart occurs. The device particularly needs to manage power in this state. In order to facilitate page/find capability, the PWD device may periodically go to a locked or even an active state; otherwise it would be inactive and unable to respond to page/find requests. Such a device is referred to as an orphan device.

The states described in FIG. 2B require that the PWD contain a timeout mechanism in addition to the DECT-level page/find capability. Moreover, an automatic page/find mechanism may be required if the PIC optimizes latency during the finding of orphan devices or auto-resume from a standby mode.

FIG. 3 provides some detail about how a wireless medical device according to the present invention may be constructed. This drawing is provided only for purposes of illustration and does not limit the invention to the device shown, and there can be many equivalents or different arrangements of the invention.

The Radio module (RM) 116 includes an transmission capability, an antenna (which does not have to be manually extended from the unit), a transmitter, and a receiver. A physical-monitor module 118 can be adapted for the specific physiological response to be measured, for example, pulse. A microprocessor (not shown) may control the RM, the physical-monitor module 118, and other functions of the device. The device can include any or all of a speaker 113, vibrator 119, and light 120, all of which can be used to notify the patient of a nurse call. The nurse-call acknowledgement 112 can be pressed by the patient to let the central-monitoring station 105 be aware that the patient knows he is to contact them or the nurses as soon as possible.

The DECT-based level page/find method can determine the status of the device either by polling the AP's 104 and 106, or central monitoring station 105. Typically, this method requires multi-AP unicasting or PIC-based broadcasting. It is presumed that if one is looking for a particular device it may be unknown as to which AP is currently associated with, and if the device is non-active, a given AP may be unaware that the device is within its transmission range. The portability of the devices while inactive would account for how a given AP may not be aware that an inactive device has moved to within the AP's transmission field. Network-loading impacts would have to be considered, particularly when a PIC-based periodic polling is used when the device comes back in range.

An example of the way to implement the methodology is to integrate a meta-state model, a specialized AP “proxy” function, and a wireless link “device call” function such that a single device-call control can cause the device to:
(1) Change to the desired state, i.e., to resume from standby (if the device is in a standby mode); and/or
(2) Indicate a distinct audial code to the patient to have the patient either press the “nurse call” button or to contact the nursing staff (if the device is not in a standby mode but is associable with the central monitoring system 105); and/or
(3) Indicate a distinct audial code to facilitate its being locatable by the clinical or bioengineering staff.

For example, in the illustration shown in FIG. 1, patient “Smith” with coronary problems is reporting a variation in heartbeat that is of concern, although not yet a full-fledged emergency. The nursing staff is aware that patient Smith is supposed to take nitroglycerin tablets every 8 hours to stabilize his heartbeat. The central-monitoring station can send out a page/find message to PWD he hears this tone to contact the nurses station immediately. Alternately, or in addition thereto, the terminal audial tone includes a buzzing sound (and sensation). In conjunction with the tone, or instead of the tone, a light may flash.

Alternatively, instead of a tone, the PWD may broadcast a pre-recorded message saying “call the nurse.” When patient Smith calls the nurse, they can verify with him if he took his medication at its last scheduled time and ask him how he feels. The PWD itself may have a switch that is pressed by the user to acknowledge receipt of the tone/message, which may or may not be transmitted back to the central site. If the patient fails to acknowledge after a certain predetermined time period, or successive tries, the PWD may automatically display an emergency audial tone so that clinicians can find patient Smith quickly, as he may be unable to communicate with the nurse's station.

In order to individually communicate with the central monitoring station bi-directionally, the PWD should have a transmission capability so that when the patient presses the acknowledge button, or activates the nurse-call button, communication between the designated AP and the nurse's station (e.g central-monitoring station) occurs. Thus, the patient and the doctor or nurse at the central-monitoring station can communicate with each other quickly and easily. Each of the PWDs may use TDMA, CDMA, GSM, FMDA, etc., to differentiate between patients in a WMTS or DECT-frequency spectrum.

In a variation of the above example, the Radio Module of PWD#1 is in a standby mode, as this PWD only contacts the central monitoring station when the patient's physiological measurement are out of range and/or a certain period of time has passed. In this case, PWD# 1 has not been in communication with the central-monitoring station in three and a half hours. The passed without any communication to check the status. As patient Smith may have walked anywhere along the hospital, all the APs may broadcast a page/find message, which in this case may be a “wake up” signal, followed by a message to the PWD to have the patient call the central-monitoring station.

Of course, if the PWD#1 is out of range of the broadcast message for the patient, there is a possibility that the device remains on the out-of-range/failing lists. In order to reduce the time a device may be unaccounted for, the device may periodically report its status. One way would be according to a timer output. For example, the device could report once for each predetermined time interval. If there is no return response, the report could be repeated immediately, or at shorter intervals until the device is back within range.

Thus, a series of method steps for the present invention may include:

a) determining the status of a radio module (RM) of one or more wireless-monitoring devices comprising one of a Patient-Wearable device (PWD) and a Patient Monitoring Device (PMD) that are adapted for dual-communication with one of or more Access Points and a central-monitoring station in a WLAN, wherein the status of the RM comprises one of a plurality of meta-states;

(b) selecting a particular wireless monitoring device for receipt of wireless transmission of a signal that is adapted for changing a meta-state of the device to a desired state if the current state of the particular wireless monitoring device is not the desired state; and

(c) activating an audial-code function of the particular wireless monitoring device by transmitting an instruction signal to the particular wireless patient-monitoring device to emit a predetermined audial code that can be heard at least by a patient being monitored by the particular wireless monitoring device, wherein the audial code in step (c) may cause the particular patient-monitoring device to emit a specific tone that indicates to a patient a nurse-call function has been broadcast so that the patient contacts a member of a nursing staff, or to play a prerecorded/preprogrammed message to a patient that requests the patient to contact a member of a nursing staff.

An additional advantage of the present invention is that the audial code comprises a page/find function so that the audial code played by the particular wireless patient-monitoring device is of a volume sufficient to permit personnel that are unaware of the wireless device's location to locate the wireless device by listening for the audial code while walking through the hospital, clinic, nursing home, hospice, medical facility, etc.

Various modifications may be made to the present invention that do not depart from the spirit of the invention or the scope of the appended claims. For example, while one protocol for wireless transmission is WMTS DECT-based protocol, any type of CDMA, TDMA, GSM, FDMA, etc., can be used for transmissions. The medical monitoring device may be worn by a patient, implanted into the patient, or externally arranged on a user's skin. The type of audial code, volume, and frequency by which it is broadcast can be suited to specific need. Visual aids can be emitted instead of or in conjunction with the audial code; for example, the device may flash a light when a page/find function is performed. The APs and the devices may communicate under WIFI such as 802.11, and the APs and the central-monitoring station may be linked by wire, fiber, Ethernet, broadband, etc., to name some of the possible connections.

1. A method for paging/finding a wireless patient-monitoring device in a WLAN network, comprising the steps of:
(a) determining a status of a radio module of one or more wireless monitoring devices comprising one of a Patient-Wearable Device and a Patient-Monitoring Device that are adapted for dual-communication with one or more Access Points and a central-monitoring station in a WLAN, wherein an overall status of the PWD/PMD comprises one of a plurality of meta-states;
(b) selecting a particular PWD/PMD for receipt of wireless transmission of a signal for changing a meta-state of the device to a desired state if a current state of the particular PWD/PMD is not in the desired state; and,
(c) activating an audial-code function of the particular PWD/PMD by transmitting an instruction signal to the particular PWD/PMD to emit a predetermined first audial-code that can be heard at least by a patient being monitored by the particular PWD/PMD.

2. The method according to claim 1, wherein the audial code in step (c) causes the particular PWD/PMD to emit a specific tone which provides an instruction for the patient to contact a nurse.

3. The method according to claim 1, wherein the audial code in step (c) causes the particular PWD/PMD to play a prerecorded/preprogrammed message to the patient.

4. The method according to claim 1, wherein the audial code in step (c) comprises a page/find function comprising a second audial code played by the particular PWD/PMD wherein said second audial code is of a volume sufficient to permit personnel that are unaware of the wireless device's location to locate the wireless device by listening for the second audial code.

5. The method according to claim 1, wherein determining of the status in step (a) of an RM of one or more wireless devices occurs by polling the one or more Access Points via unicasting.

6. The method according to claim 1, wherein determining of the status in step (a) of an RM of one PWD/PMD occurs by polling the one or more Access Points via PIC based broadcasting.

7. The method according to claim 1, wherein the RM of one or more PWD/PMDs uses a Wireless Medical Telemetry System WLAN DECT-based protocol.

8. The method according to claim 7, wherein the overall status of the plurality of meta-states of the PWD/PMD in step (a) includes operational, standby, steep, active, locked, seeking, inactive, PIC-associated, PIC-unassociated, PIC-connected, PIC-Unconnected, AP-associated, AP-unassociated, active timing, inactive timing and a designated out-of-range state if the particular PWD/PMD selected in step (a) does not respond.

9. The method according to claim 8, wherein the meta-state in step (b) of the RM of the particular PWD/PMD is changed to an active state.

10. The method according to claim 8, wherein the meta-states further include: IP aware, IP-unaware, booting and rebooting.

11. The method according to claim 7, wherein the PWD/PMD periodically broadcasts the status to the one or more Access Points if the device has not been polled by a predetermined amount of time.

12. A page/find system for wireless medical monitoring devices comprising:
at least one of a central-monitoring station and a plurality of Access Points;
a plurality of wireless medical monitoring devices comprising one of a patient wearable device and a Patient Monitoring Device that are adapted for dual-communication with the plurality of Access Points and the central-monitoring station in a WLAN, wherein the PWD/PMD devices include a plurality of meta-states;
wherein at least said one central monitoring station and plurality of Access Points broadcasts a page/find message to a particular PWD/PMD that signals the particular wireless medical-monitoring device to emit an audial tone at a predetermined volume that can be heard by a patient.

13. The system according to claim 12, wherein the first audial tone emitted by the particular PWD/PMD comprises a tone that indicates a call nurse function.

14. The system according to claim 12, wherein the predetermined volume is sufficiently loud enough to permit personnel within a facility to locate the particular PWD/PMD.

15. The system according to claim 12, wherein the central station 105 and plurality of AP's communicate with the PWD/PMD by a Wireless Medical Telemetry System using a WLAN DECT-based protocol.

16. The system according to claim 12, wherein the central station 105 and the plurality of AP's poll a status of the PWD/PMD via a PIC based broadcast.

17. A patient monitoring device comprising:
means for monitoring certain physiological responses of a patient;
a radio module that communicates with one of a central-monitoring station or a plurality of Access Points;
audial-code emission means, wherein in response to receipt of a signal, said device emits an audial-code indicating a nurse-call function.

18. A patient monitoring device comprising:
means for monitoring certain physiological responses of a patient;
a radio module that communicates with one of a central-monitoring station or a plurality of Access Points; and
audial-code emission unit, wherein in response to receipt of a signal, said device activates a transducer that emits a first audial code at a volume sufficient for a patient to become aware that a nurse-call function has occurred; and,
an acknowledgement button that when activated indicates that a nurse-call function has been acknowledged by the patient.

19. The patient-monitoring device according to claim 18, wherein the audial-emission unit emits a second audial code relatively louder than the first audial code.

20. The patient-monitoring device according to claim 18, wherein the audial-emission unit includes a vibrator or a light.
